(19) United States
(12) Patent Application Publication
(10) Pub. No.: US 2021/0148096 A1
(43) Pub. Date: May 20, 2021

(54) PASSIVE MOISTURE HARVESTING APPARATUS AND METHOD

(71) Applicant: Emily Tianshi, San Diego, CA (US)

(72) Inventor: Emily Tianshi, San Diego, CA (US)

(21) Appl. No.: 16/686,126

(22) Filed: Nov. 16, 2019

(51) Int. Cl. E03B 3/28

(52) U.S. Cl. CPC E03B 3/28; B01D 5/009

(57) ABSTRACT

An apparatus and method to harvest moisture from the atmosphere with adequate moisture content without using external energy is disclosed. The apparatus comprises a plate having a non-horizontal surface consisting of majority hydrophilic areas to promote water droplet condensation and minority water hydrophobic water repelling areas to increase water droplet mobility. The non-horizontal surface of the moisture harvesting apparatus may comprise ridges and valleys formed in the approximate direction from about the high end to about the low end of the non-horizontal surface to further increase water droplet mobility.

### FIELD OF THE INVENTION

The present invention relates generally to moisture harvesting from the atmosphere with adequate moisture content, and more particularly to moisture harvesting by modifying, the wettability properties of the moisture harvesting surface.

### BACKGROUND OF THE INVENTION

Freshwater, scarcity has caused critical environmental issues in global agriculture, plant/animal habitats, hydropower production, recreation, and much more. With the human population increasing, water scarcity is expected to become a more challenging issue to people and governments.

While most efforts have been focused on utilizing limited water resources in a more efficient way, a non-traditional water resource, the atmosphere, has been attracting more and more attention due to recent material and surface science progress. The World Economic Forum named water harvesting from the atmosphere the second emerging technology in 2017 [“Harvesting Clean Water from Air”, The World Economic Forum: Top 10 Emerging Technologies 2017 (2017). Retrieved from http://www3.weforum.org/docs/WEF_Top_10_EmergingTechnologies_report_2 017.pdf]. And, Chilean investigators estimated that capturing 4% of the moisture in the atmosphere could be sufficient to meet the demands of the nation's driest areas [David L. Chandler, “How to get fresh water out of thin air”, MIT News (Aug. 30, 2013). Retrieved from http://news.mit.edu/2013/how-to-get-fresh-water-out-of-thin-air-0830].

The most current moisture harvesting methods are categorized according to condensation mechanisms. Since the moisture in the atmosphere condenses to water when the moisture content is oversaturated, the harvesting methods can be divided into “active” and “passive”. For active moisture harvesting, normally a refrigeration apparatus is required. This type of harvesting is disclosed in U.S. Pat. No. 6,960,243 by Smith et al, U.S. Pat. No. 6,360,549 by Spletzer et al, and U.S. Pat. No. 5,845,504 by LeBleu. The main focus of the active approach has been to improve water capturing efficiency. But the type of harvesting is normally expensive and service demanding due to the refrigeration mechanism involved. The passive moisture harvesting methods normally do not require external power, which makes it less expensive for ownership and operation. But harvesting efficiency may be lower than that of the active methods. The main idea behind passive moisture harvesting is to produce smaller quantities of water at more affordable cost. U.S. Pat. No. 6,116,034 by Alexeev et al discloses a system for condensation and collection of atmospheric moisture that having condensation surface within the system and an, aperture pipe at the top. Hot water is introduced into the system to warm up the air entering the system from the surroundings, so that the moisture laden air rises up to exit the aperture pipe and condenses moisture on the condensation surface. In U.S. Pat. No. 5,846,296 Krumsvik teaches a method for recovering and/or purifying water which is absorbed from a humid atmosphere, wherein the moisture from the air is adsorbed on a suitable medium by means of cooling. By the application of heat to the medium in a closed room, the moisture is transferred to a condenser where it passes into a liquid state and is collected.

In theory, the overall moisture harvesting rate is mainly determined by two factors: 1) how quickly moisture can condense on a harvesting surface; 2) how quickly condensed water droplets can roll off the surface for collection. Surface wettability and water droplet mobility are conflicting requirements on surface properties. For example, when other conditions, such as ambient humidity, airflow rate, air temperature, surface area, and etc., are identical, a more hydrophilic surface would have a higher moisture condensation rate. However, a highly hydrophilic surface may also reduce water transportation off the surface due to strong affinity of the water droplets to the surface. The condensation of moisture directly on a dry surface is much more efficient than on a surface already covered with water [Neumaan, et al, “The role of contact angles and contact angle hysteresis in dropwise condensation heat transfer”, Intl J. Heat Mass Transfer, 21, P. 947, (1978)]. If the water droplets formed on the surface cannot be removed quickly, further water condensation will slow down, resulting in overall lower moisture harvesting efficiency. When water droplets are removed from the surface more quickly, more water can condense on the surface, which increases the overall rate of harvesting.

If water mobility on a hydrophilic surface can be improved without compromising its condensation performance, the result may be a highly efficient moisture harvesting material and device. Such a device may be constructed in a way that the water removal rate is equivalent to the water condensation rate. In this way fresh surface is always exposed to the atmosphere for maximum condensation.

The present invention is inspired by the needle surface structure and properties of the Torrey Pine trees (Pinus torreyana), an endangered species, which only grow in two coastal areas in California, USA, that are next to the ocean, the Torrey Pines State Natural Reserve and Santa Rosa Island, where heavy fog usually form but have very little rain. A study indicated that the Torrey Pines State Natural Reserve receives 245 mm of annual precipitation, while the evapotranspiration level is at 1,024 mm [Wang, et al. , “ClimateWNA—high-resolution spatial climate data for western North America”, Journal of Applied Meteorology and Climatology, 51, 16-29, (2012)]. The difference could very well be contributed to the trees' moisture harvesting capability. While most other pine needles are covered with waxy cuticles, which prevents water from evaporating, the Torrey Pine needle surfaces have alternating hydrophilic and hydrophobic surface patterns to harvest water from moisture in order to survive dry climates [Shaw, “Facts About Pine Needles.” Sciencing, (Aug. 19, 2018). Retrieved from http://sciencing.com/pine-needles-6455979.html].

Therefore, there is a need to develop an energy saving apparatus and method to harvest water from the atmosphere by modifying the properties of the moisture harvesting surface so that moisture harvesting efficiency is improved. Consequently, water is derived from the atmosphere in order to benefit humans and the environment.

### SUMMARY OF THE INVENTION

It is therefore an object of the invention to provide a passive apparatus and method to harvest water from the atmosphere without using external energy to benefit the environment.

According to one aspect of the invention, the moisture harvesting apparatus comprises a plate having a non-horizontal surface consisting of a majority hydrophilic areas to promote water droplet condensation and a minority hydrophobic water repelling areas to increase water droplet mobility.

According to another aspect of the invention, the water condensing areas. and water repelling areas of the non-horizontal surface o the moisture harvesting apparatus are arranged in alternating patterns.

According to yet another aspect of the invention, the non-horizontal surface of the moisture harvesting apparatus has ridges and valleys formed in the approximate direction from about the high end to about the low end of the non-horizontal surface to further increase water droplet mobility.

### BRIEF DESCRIPTION OF THE DRAWINGS

These and other objects and features of the invention will become more fully apparent from the following description and appended claims taken in conjunction with the following drawings, where like reference numbers and alphanumeric names indicate identical or functionally similar elements.

FIG. 1 shows a water droplet on a horizontal surface on the top side of a plate, wherein a contact angle α is formed between the water surface and the plate surface where they meet;

FIG. 2 depicts a top view of multiple water droplets of different sizes covering a harvesting surface;

FIG. 3 shows a binary harvesting surface made of majority hydrophilic water condensing areas divided by minority hydrophobic repelling areas, wherein water droplets cover the hydrophilic areas and are repelled by hydrophobic areas;

FIG. 4 is an inclined plate with the harvesting top surface having contoured ridges and valleys running straight down from the top of the plate surface to the bottom of the plate surface wherein the plate and the horizontal plane thrills an angle β; and

FIG. 5 is an inclined plate with the harvesting top surface having multifaceted ridges and valleys running straight down from the top of the plate surface to the bottom of the plate surface wherein the plate and the horizontal plane forms an angle β.

### DETAILED DESCRIPTION OF THE INVENTION

The present description will be directed in particular to elements forming part of or cooperating more directly with, apparatus and methods in accordance with the present invention. It is to be understood that elements not specifically shown or described may take various forms well known to those skilled in the art.

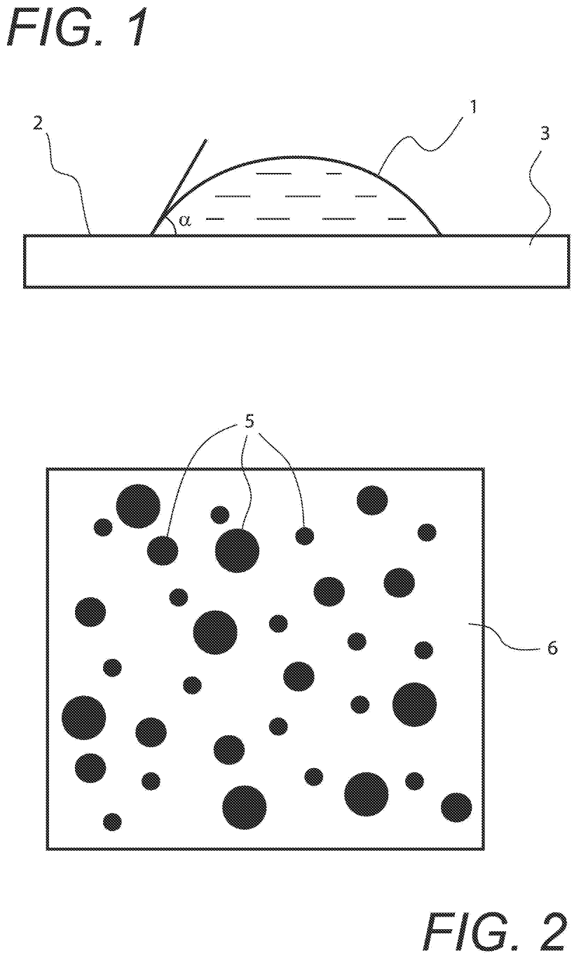

FIG. 1 shows a water droplet 1 resting on a horizontal surface 2 of a plate 3. Surface tension causes water droplet 1 to bead up from surface 2. At the edge of water droplet, a contact angle α is formed between horizontal surface 2 and the sloped and curved surface of water droplet 1. The magnitude of contact angle a depends or the wettability property of surface 2. A smaller contact angle a means that the water drop has a higher tendency to cling on the surface and spreads to cover a wider area, forming a lower drop height. When a surface has a high tendency to cause a water droplet to spread thin or when the contact angle small, it is considered to be hydrophilic. On the other hand, when a surface has a high tendency to cause a water droplet to bead up or the contact angle is large, it is considered to be hydrophobic.

Due to its affinity to water, a hydrophilic surface has the tendency to attract moisture in the air to condense on it. However, using a homogeneous hydrophilic surface to condense moisture may not be as effective for harvesting moisture as one might expect. As illustrated in FIG. 2, many water droplets 5 are formed on a horizontal hydrophilic surface 6. Because of the small contact angle due to the hydrophilic surface property, each droplet 5 is clinging to the hydrophilic surface 6, expanding in all directions and farming a thinly covered area. The large contact area that droplets 5 cover make removal of water droplets 5 difficult. Therefore, in the beginning, surface 6 is effective for condensing moisture, But due to the removal difficulty of water droplets 5, soon surface 6 is covered up and condensation is slowed down.

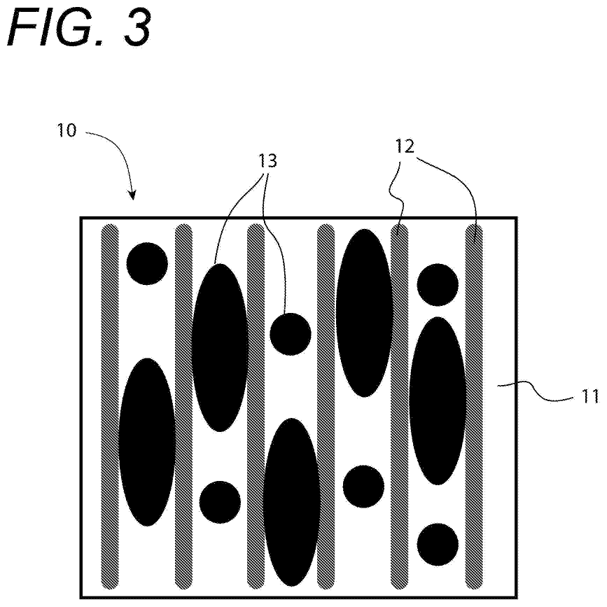

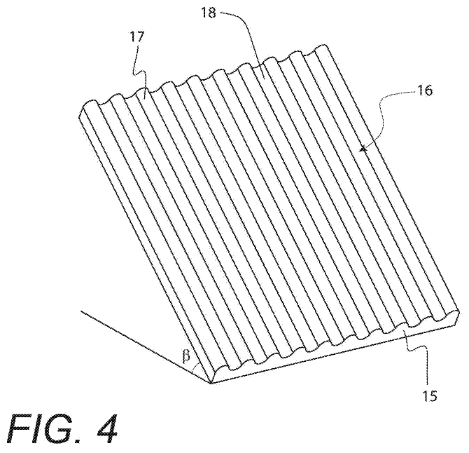

A solution to the problem is to form hydrophobic areas on the harvesting surface to limit the spreading of the water droplets, thus forming a binary surface composed of hydrophilic areas for water droplet condensation and hydrophobic areas to limit the spread of the droplets formed, Such a binary surface solution is exemplified in FIG. 3, where straight columns of hydrophobic repelling areas 12. are formed on the plate 10, each between larger adjacent hydrophilic condensing surfaces 11. On a two dimensional homogeneous surface, adding periodic hydrophobic repelling areas may serve the purpose of decreasing water droplet size to increase water mobility. Hydrophilic and hydrophobic are relative in terms of contact angle of a water droplet on a specific surface. A surface is considered hydrophobic compared to another surface if its water drop contact angle is 10° or even 20° larger. For example, if surface A has contact angle α<20°, and surface B has α>40°, one may consider that surface A is hydrophilic and surface B is hydrophobic.

In FIG. 3, when moisture in the air is attracted and condenses on a hydrophilic surface 11 to form droplets 13, these droplets are repelled by the adjacent hydrophobic areas 12, thus limiting the spread of the droplets. Hence, droplets 13 are limited in the horizontal direction and may extend more in the vertical orientation, which helps the droplets overcome the clinging force and drip down more easily if surface 11 is tilted. Given the same water droplet volume, the limited contact area due to the repelling force from repelling areas 12 increases the water droplet height, and die deformed water droplet shapes as depicted in FIG. 3 may expedite water droplet removal from the surface.

Repelling areas 12 in FIG. 3 may take different shapes. For example, each column of hydrophobic area 12 may be composed of many small islands forming a pattern, such as a straight line of identical shaped and sized small islands or a matrix of identical small islands. Also, instead of periodically spaced, repelling areas 12 may be scattered on the harvesting surface as long as they effectively separate condensing areas 11. In any case, the binary surface of hydrophilic and hydrophobic areas should be mostly composed of hydrophilic condensing areas which are beneficial to water droplet condensation. Then the smaller hydrophobic repelling areas help limit the spreading of the water droplets and enhance mobility. Preferably, hydrophilic condensing areas cover more than 80% of the entire moisture harvesting surface, with hydrophobic repelling areas covering the rest.

When periodically spaced, the width of each hydrophobic column may be 1 μm to 1 mm, and the distance between adjacent hydrophobic columns may be 10 μm to 100 mm. And the hydrophobic columns may take different shapes, e.g., straight, curved, and etc.

Preferably, the harvesting surface is set up inclined instead of horizontally. In this way, gravity helps water droplets flow down the slope for collection. For a passive moisture harvesting apparatus, the most efficient way is to use gravity to remove water from the surface. Thus, no external energy is used for the benefit of environmental protection.

A preferred embodiment is shown in FIG. 4, where an inclined plate 15 forms an angle β with the horizontal plane. The top harvesting surface 16 of the plate 15 has straight ridges 17 and valleys 18 that are contour shaped. Ridges 17 and valleys 18 are aligned in the direction from the top end of the plate 15 to the bottom end of the plate 15. But they can take other arrangements as well as suitable for specific application. As with the previous discussions, the majority of top surface 16 is covered by hydrophilic condensing areas to attract moisture to condensate. The water droplets formed run down from ridges 17 to adjacent valleys 18 by gravity, and then run down the slope of surface 16 in valleys 18 to be collected. Small hydrophobic repelling areas may cover partial areas of valleys 18, preferably along the centerlines of valleys 18, to separate water droplets in order to increase mobility. Optionally, small hydrophobic repelling areas may cover partial areas of ridges 17 in order to cause water droplets to move to valleys 18. Each column of hydrophobic area may be composed of many small islands forming a pattern, such as a straight line of identical shaped and sized small islands or a matrix of identical small islands. Also, instead of periodically spaced, repelling areas may be scattered in the valleys and on ridges as long as they effectively separate condensing areas. The cross-sectional profile of ridge 17 and valley 18 may be sinusoidal, i.e., the width of the ridge is equal to that of the valley. In another embodiment, the width of the ridge is formed smaller than that of the valley. Preferably, each hydrophobic column is about 1 μm to 1 mm wide, and the distance between the adjacent ridges is about 10 μm to 100 mm.

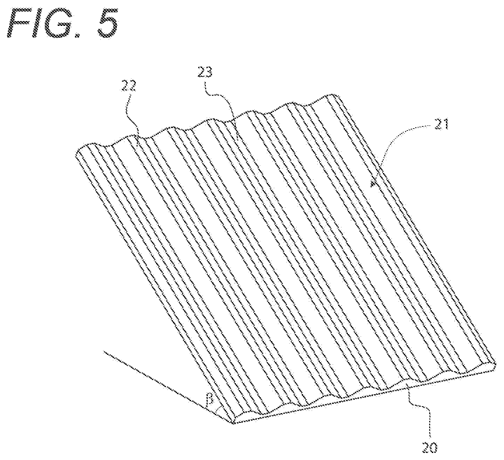

FIG. 5 shows an alternative embodiment of FIG. 4, where inclined plate 20 forms an angle β with the horizontal plane and the top harvesting surface 21 of plate 20 has straight ridges 22 and valleys 23 running from the top end of plate 20 to the bottom end of plate 20. However, instead of being contoured, top surface 21 is made of multi-faceted straight planes. The same as in FIG. 4, the majority of top surface 20 is covered by hydrophilic areas to attract moisture to condense. The water droplets formed run down from ridges 22 to adjacent valleys 23 by gravity, and then run down the slope of surface 21 in valleys 23 to be collected. Small hydrophobic areas may cover partial areas of valleys 23, preferably along the centerlines of valleys 23, to separate water droplets in order to increase mobility. Optionally, small hydrophobic areas may cover the partial areas of ridges 22 in order to cause water droplets to move to valleys 23.

In FIGS. 4 and 5, the ridges and valleys may take different orientation arrangements. For example, they may follow curved paths, instead of straight lines from top to bottom of the harvesting surface depending on specific application. And the ridges and valleys may lake a direction that forms an angle with the line of gravity.

The inclination angle β of plate 15 of FIG. 4 or plate 20 of FIG. 5 may range from near horizontal (>0°) to vertical (90°). Also, plate 15 or plate 20 may be constructed to have both front surface and back surface as moisture harvesting surfaces, to maximize moisture harvesting rate. This type of configuration is especially effective when plate 15 or plate 20 is erected at vertical or near vertical position.

The binary hydrophilic and hydrophobic surface structure in FIG. 4 or 5 is preferably fabricated on a rigid substrate material that is robust against weather conditioning, including humidity, UV light, and temperature. The rigid substrate material is selected from a group consisting essentially of plastic, metal, concrete, cement, wood, bamboo, and etc. Preferably, the substrate material has high thermal conductivity. When supported by a structure with high thermal conductivity as well, heat conduction ensures that the temperature of the substrate material stays close to that of the supporting structure. When warmer air hits the cooler harvesting surface, moisture condensation occurs more easily. The hydrophilic and hydrophobic areas may be laminated or coated on the substrate material. One method is to coat a layer of hydrophilic layer covering the entire surface and then to coat small areas of a hydrophobic layer on top of the hydrophilic layer. Another method is to coat both hydrophilic and hydrophobic areas in one layer, for example, by digital printing.

Plate 15 of FIG. 4 or plate 20 of FIG. 5 may be made like a roof tile that can be installed to connect with one another to cover a large area, e.g., to cover part of or the entire roof of a house.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

1. An apparatus for harvesting moisture in the air with adequate moisture content, comprising:
a plate having a non-horizontal surface consisting of majority water condensing areas and minority water repelling areas that are surrounded by the majority water condensing areas.

2. The apparatus of claim 1, wherein:
the water condensing areas and water repelling areas of the non-horizontal surface are arranged in alternating patterns, and the water repelling areas form columns following the approximate direction from about the high end to about the low end of the non-horizontal surface.

3. The apparatus of claim 2, wherein:
the column width of each water repelling area is about 1 μm to 1 mm, and the spacing between adjacent columns is about 10 μm to 100 mm.

4. The apparatus of claim 1, wherein:
the non-horizontal surface has ridges and valleys between adjacent ridges;
wherein the ridges and the valleys are formed in the approximate direction from about the high end to about the low end of the non-horizontal surface; and
wherein a column of water repelling area is formed in each valley following the valley centerline and is surrounded by water condensing areas.

5. The apparatus of claim 4, wherein:
a column of water repelling area is formed on each ridge following the ridge centerline and is surrounded by water condensing areas.

6. The apparatus of claim 4, wherein:
each column of water repelling area consists of a plurality of small islands forming a pattern.

7. The apparatus of claim 4, wherein:
the column width of each water repelling area is about 1 μm to 1 mm.

8. The apparatus of claim 4, wherein:
the distance between adjacent ridges is about 10 μm to 100 mm.

9. The apparatus of claim 1, wherein:
the plate includes a rigid substrate material selected from a group consisting essentially of plastic, metal, concrete, cement, wood, and bamboo.

10. The apparatus of claim 1, wherein:
the water condensing areas have a water contact angle of less than 20 degrees and the water repelling areas have a contact angle greater than 40 degrees.

11. The apparatus of claim 1, wherein:
the non-horizontal surface forms an angle with the horizontal plane from greater than 5° to 90°.

12. A method for harvesting water in the air with adequate moisture content, comprising the steps of:
establishing a plate with a non-horizontal surface;
forming water condensing areas to cover the majority of the non-horizontal surface; and
forming water repelling areas to cover the areas that are not covered by the water condensing areas.

13. The method of claim 12, wherein:
the water condensing areas and water repelling areas of foe non-horizontal surface are arranged in alternating patterns, and the water repelling areas form columns following the approximate direction from about the high end to about the low end of the non-horizontal surface.

14. The method of claim 13, wherein:
the column width of each water repelling area is about 1 μm to 1 mm, and the spacing between adjacent columns is about 10 μm to 100 mm.

15. The method of claim 12, wherein:
the non-horizontal surface has ridges and valleys between adjacent ridges;
wherein the ridges and valleys are formed in the approximate direction from about the high end to about foe low end of the non-horizontal surface; and
wherein a column of water repelling area is formed in each valley following foe valley centerline and is surrounded by water condensing areas.

16. The method of claim 15, wherein:
a column of water repelling area is formed on each ridge following the ridge centerline and is surrounded by water condensing areas.

17. The method of claim 15, wherein:
each column of water repelling area consists of a plurality of small islands forming a pattern.

18. The method of claim 15, wherein:
the column width of each water repelling area is about 1 μm to 1 mm.

19. The method of claim 15, wherein:
the distance between adjacent ridges is about 10 μm to 100 mm.

20. The method of claim 12, wherein:
the plate includes a rigid substrate material selected from a group consisting essentially of plastic, metal, concrete, cement, wood, and bamboo.
